(19) United States
(12) Patent Application Publication
(10) Pub. No.: US 2025/0179399 A1
(43) Pub. Date: Jun. 5, 2025

(54) SOLID SURFACTANT IN UNIT DOSE PRODUCT FOR IMPROVED MILDNESS

(71) Applicant: Henkel AG & Co. KGaA, Duesseldorf (DE)

(72) Inventors: Janet COOPE-EPSTEIN, Trumbull, CT (US); Daniel Thomas PIORKOWSKI, Fairfield, CT (US)

(73) Assignee: Henkel AG & Co. KGaA, Duesseldorf (DE)

(21) Appl. No.: 18/895,898

(22) Filed: Sep. 25, 2024

Related U.S. Application Data
(60) Provisional application No. 63/604,502, filed on Nov. 30, 2023.

(51) Int. Cl. C11D 17/04; C11D 1/12; C11D 3/34; C11D 3/386

(52) U.S. Cl. CPC C11D 17/045; C11D 1/126; C11D 3/3409; C11D 3/386; C11D 17/043; C11D 17/044; C11D 2111/12

(57) ABSTRACT

The present disclosure provides a unit dose product comprising a water-soluble film material comprising first and second compartments. The first compartment enclosing a liquid composition comprising water, non-aqueous solvent, and optionally one or more additives. The second compartment enclosing a solid composition comprising a solid methyl ester sulfonate and/or a solid cocoyl isethionate. The present disclosure further provides a unit dose product comprising a water-soluble film material comprising first and second compartments. The first compartment enclosing a liquid composition comprising a non-aqueous solvent comprising polyethylene glycol and glycerin, and a surfactant selected from an alcohol ethoxylate, an alkyl ether sulfate, a methyl ester ethoxylate, coco fatty acid, an alkyl polyglucoside, and any combination thereof. The second compartment enclosing a powder composition comprising a solid methyl ester sulfonate and/or a solid cocoyl isethionate, and a solid flow aid.

### BACKGROUND

Laundry detergent compositions contain surfactants which impart good cleaning performance. However, many surfactant compositions can cause skin and eye irritation. Preferred surfactants for efficacy have included the anionic linear alkylbenzene sulfonates (LAS) that can be a harsh additive to detergent compositions, and replacements such as alcohol ethoxysulfonates can contain traces of regulated compounds. Further, solvents included in detergent compositions can be allergens. Propylene glycol was named the 2018 allergen of the year by the American Contact Dermatitis Society.

Packaging detergent compositions in unit dose products is a preferred consumer product for use in laundry applications. Such unit dose products have several advantages, including convenience of use and dispensing, lower cost per use, and minimized skin contact with potentially irritating cleaning compositions. However, formulating detergent compositions to be packaged in unit dose film pouches presents additional challenges.

There is a need for a unit dose product comprising a detergent composition that can effectively clean textiles while retaining mildness and limiting allergenic compounds.

### BRIEF SUMMARY

The present disclosure relates to a unit dose product comprising:
a water-soluble film material comprising a first compartment and a second compartment;
the first compartment enclosing a liquid composition comprising about 5 to about 20 weight percent (wt %) water relative to the liquid composition, a non-aqueous solvent, and optionally an additive selected from surfactant, a base, an anti-redeposition agent, a performance polymer, a defoamer, an enzyme, a chelating agent, an optical brightener, a bitterant, a corrosion inhibitor, and any combination thereof; and
the second compartment enclosing a solid composition comprising a solid methyl ester sulfonate (MES) and/or a solid cocoyl isethionate.

In an aspect, a Zein score of a combined composition comprising the liquid and solid compositions dissolved in water is not more than 2% dissolved zein when tested on a 3% dilution. In an aspect, the Zein score of a combined composition is not more than 1% dissolved zein when tested on a 3% dilution.

In an aspect, the solid composition is a powder or granule.

In an aspect, the solid composition comprises about 5 to about 30 wt % of solid methyl ester sulfonate (MES) relative to the total unit dose product.

In an aspect, the solid composition further comprises a solid flow aid comprising a chloride, a bromide, an iodide, a fluoride, a nitrate, a nitrite, a sulfate, a sulfite, a sulfide, a phosphate, a phosphide, a carbonate, a bicarbonate, a citrate, silica, calcium oxide, a silicate, an aluminate, a stearate, clay, flour, fly ash, starch, zeolite, or any combination thereof.

In an aspect, the solid composition further comprises an additive selected from an anti-redeposition agent, enzyme, chelating agent, and any combination thereof.

In an aspect, the liquid composition comprises an alcohol ethoxylate (AE), an alkyl ether sulfate (AES), a methyl ester ethoxylate, a coco fatty acid, an alkyl polyglucoside, or any combination thereof. In an aspect, the liquid composition comprises an alcohol ethoxylate (AE) and an alkyl ether sulfate (AES). In an aspect, the liquid composition does not comprise a linear alkylbenzene sulfonate.

In an aspect, the non-aqueous solvent comprises an alcohol, a polyol, or a combination thereof. In an aspect, the non-aqueous solvent comprises about 5 to about 35 wt % polyethylene glycol, 0 wt % to about 10 wt % propylene glycol, and about 10 to about 25 wt % glycerin. In an aspect, the non-aqueous solvent comprises polyethylene glycol, propylene glycol, and glycerin in a weight ratio of about 3-5:1:1.

In an aspect, the liquid composition has a pH of about 6.5 to about 10. In an aspect, the liquid composition has a pH of about 7 to about 8.

In an aspect, the liquid composition comprises a base selected from the group consisting of monoethanolamine, diethanolamine, triethanolamine, methyl diethanolamine, a hydroxide, a tetraborate, a phosphate, a carbonate, a bicarbonate, or a combination thereof.

In an aspect, the liquid composition comprises an enzyme selected from a protease, an amylase, a mannanase, a lactase, a lipase, a perhydrolase, an oxidoreductase, a cellulase, a pectinase, or any combination thereof.

In an aspect, the water-soluble film material in the unit dose product comprises polyvinyl alcohol (PVOH) or polyvinyl acetate (PVA).

The present disclosure further relates to a unit dose product comprising
a water-soluble film material comprising a first compartment and a second compartment;
the first compartment enclosing a liquid composition comprising
a non-aqueous solvent comprising polyethylene glycol and glycerin, and
a surfactant selected from an alcohol ethoxylate (AE), an alkyl ether sulfate (AES), a methyl ester ethoxylate, a coco fatty acid, an alkyl polyglucoside, and any combination thereof; and
the second compartment enclosing a powder composition comprising
a methyl ester sulfonate (MES) of the formula R¹CH(SO₃X¹)(C(═O)OCH₃), wherein R¹ is a C₁₂-C₂₄ alkyl, and X¹ is a cation that balances the charge and/or
a cocoyl isethionate of the formula R²C(O)OCH₂CH₂SO₃X², wherein R² is a C₇-C₁₇ alkyl and X² is a cation that balances the charge and
a solid flow aid.

In an aspect, R¹ is a C₁₆-C₁₈ alkyl of the methyl ester sulfonate (MES).

### DETAILED DESCRIPTION

Provided herein is a unit dose product comprising a water-soluble film material comprising a first compartment and a second compartment; the first compartment enclosing a liquid composition comprising about 5 to about 20 weight percent (wt %) water relative to the liquid composition, a non-aqueous solvent, and optionally an additive selected from surfactant, a base, an anti-redeposition agent, a performance polymer, a defoamer, an enzyme, a chelating agent, an optical brightener, a bitterant, a corrosion inhibitor, and any combination thereof; and the second compartment enclosing a solid composition comprising a solid methyl ester sulfonate (MES) and/or a solid cocoyl isethionate.

Non-limiting examples of the various aspects are shown in the present disclosure.

### Definitions

In order that the present disclosure can be more readily understood, certain terms are first defined. Additional definitions are set forth throughout the detailed disclosure.

All of the various aspects, embodiments, and options disclosed herein can be combined in any and all variants unless otherwise specified. Terms in this application control in the event of a conflict with a patent or publication term that is incorporated by reference.

As used herein, “a,” “an,” or “the” means one or more unless otherwise specified.

Furthermore, “and/or,” where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

Open terms such as “include,” “including,” “contain,” “containing” and the like mean “comprising.” The term “or” can be conjunctive or disjunctive.

It is understood that wherever aspects are described herein with the language “comprising,” otherwise analogous aspects described in terms of “consisting of” and/or “consisting essentially of” are also provided.

Some inventive embodiments contemplate numerical ranges. Every numerical range provided herein includes the range endpoints as individual inventive embodiments. When a numerical range is provided, all individual values and sub-ranges therein are present as if explicitly written out.

The term “about” includes the recited number ±10%. For example, “about 10” means 9 to 11.

The phrase “substantially free of” means that a composition contains little no specified ingredient/component, such as less than about 5 wt %, less than about 4 wt %, less than about 3 wt %, less than about 2 wt %, less than about 1 wt %, less than about 0.5 wt %, less than about 0.3 wt %, less than about 0.2 wt %, less than about 0.1 wt %, or 0 wt % of the specified ingredient. For example, in one aspect, the detergent composition can be substantially free of linear alkylbenzene sulfonates (LAS).

As used herein, the “%” described in the present application refers to the weight percentage unless otherwise indicated.

The term “at least” prior to a number or series of numbers is understood to include the number adjacent to the term “at least,” and all subsequent numbers or integers that could logically be included, as clear from context. For example, “at least one enzyme” means that 1, 2, 3, or more enzymes are included in the composition. When at least is present before a series of numbers or a range, it is understood that “at least” can modify each of the numbers in the series or range. “At least” is also not limited to integers (e.g., “at least 5%” includes 5.0%, 5.1%, 5.18% without consideration of the number of significant figures).

Unless states otherwise, the term “by weight of the composition” refers to a composition of a final product derived from a process, unless otherwise defined.

The terms “process” and “method” can be used interchangeably.

The terms “alkoxylate” or “alkoxylated” as used in the present application means: the presence of an polyaliphatic ether moiety in a compound, such as ethoxylate (—CH₂CH₂O—) or propoxylate (—CH(CH₃)CH₂O—). A polyethoxylate is multiple repeat units of ethoxylate ((—CH₂CH₂O—)ₙ), and a polypropoxylate is multiple repeat units of propoxylate ((—CH(CH₃)CH₂O—)ₘ). The subscripts “n” and “m” are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

The terms “ethoxylate” or “ethoxylated” as used in the present application means the presence of multiple repeat units of ethoxylate ((—CH₂CH₂O—)ₙ). The subscript “n” is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

The term “Zein score” or “Zein number” as used in the present application refers to a score or number measured using a Zein test (see, e.g., Gott, E., Aesthet. Medzin., Tenside 15: 313 (1966)), as described in the examples. A Zein test determines the extent of denaturation of Zein corn protein after exposure to a surfactant for a given period of time. Generally, the higher the Zein score, the greater the skin irritation potential.

In some aspects, the detergent compositions described herein have a Zein score of not more than about 2% dissolved zein when tested at a 3% dilution. In other aspects the detergent compositions described herein have a Zein score of not more than 1% dissolved zein when tested at a 3% dilution. In other aspects, the detergent compositions described herein at a 3% dilution have a Zein score of from about 0.01% to about 2%, from about 0.01% to about 1.75%, about 0.01% to about 1.5%, or about 0.01% to about 1.25%, or about 0.01% to about 1% dissolved zein.

The term % swelling as used in the present application means the percent increase or decrease in weight, for example the weight of a pouch strip, such as a polyvinyl alcohol strip, following submersion in a detergent composition for a given period of time, for example twenty-four hours (hr). The % swelling is calculated as described in the examples by taking a post-soaking weight, subtracting an initial, pre-soaking weight, and dividing by the initial, pre-soaking weight.

In some aspects, the detergent composition described herein has a % swelling rate of not more than about 30% following a 24 hr test. In some aspects, the detergent composition described herein has a percent swelling from about 20% to about 30% following a 24 hr test, or about 21% to about 30%, about 22% to about 30%, about 23% to about 30%, about 24% to about 30%, about 25% to about 30%, about 26% to about 30%, about 27% to about 30%, about 28% to about 30%, or about 29% to about 30%.

### Detergent Composition

In some aspects, the present disclosure is directed to a unit dose product comprising: a water-soluble film material comprising a first compartment and a second compartment; the first compartment enclosing a liquid composition comprising about 5 to about 20 weight percent (wt %) water relative to the liquid composition, a non-aqueous solvent, and optionally an additive selected from surfactant, a base, an anti-redeposition agent, a performance polymer, a defoamer, an enzyme, a chelating agent, an optical brightener, a bitterant, a corrosion inhibitor, and any combination thereof; and the second compartment enclosing a solid composition comprising a solid methyl ester sulfonate (MES) and/or a solid cocoyl isethionate. When placed in water (e.g., in a method of washing a textile), the liquid composition and solid composition together form a detergent composition.

It was discovered that a mild composition (i.e., a composition with a low Zein score) can be provided when a solid methyl ester sulfonate (MES) and/or a solid cocoyl isethionate is used as a replacement for a linear alkylbenzene sulfonate in a detergent composition. In some aspects, the detergent composition (i.e., the combined liquid composition and solid composition) has a Zein score that is not more than 2% dissolved zein when tested on a 3% dilution of the detergent composition when measured in accordance with the method set forth herein and in Gott (Aesthet. Medzin., Tenside 15: 313 (1966)), the disclosure of which is incorporated herein by reference in its entirety. In some aspects, the detergent composition has a Zein score of not more than 1% dissolved zein when tested on a 3% dilution. In other aspects, the detergent composition has a Zein score of from about 0.01% to 2%, from about 0.01% to about 1.75%, about 0.01% to about 1.5%, or about 0.01% to about 1.25%, or about 0.01% to about 1% dissolved zein, when measured at a 3% dilution.

To improve mildness, the solid composition comprises a solid methyl ester sulfonate (MES) and/or a solid cocoyl isethionate.

In some aspects, the solid methyl ester sulfonate (MES) is of the formula R¹CH(SO₃X¹)(C(═O)OCH₃), wherein R¹ is a C₁₂-C₂₄ alkyl, and X¹ is a cation that balances the charge. The C₁₂-C₂₄ alkyl group is an alkyl comprising 12 to 24 carbons (e.g., 12 to 22 carbons, 12 to 20 carbons, 12 to 18 carbons, 12 to 16 carbons, 12 to 14 carbons, 14 to 24 carbons, 14 to 22 carbons, 14 to 20 carbons, 14 to 18 carbons, 14 to 16 carbons, 16 to 24 carbons, 16 to 22 carbons, 16 to 20 carbons, 16 to 18 carbons, 18 to 24 carbons, 18 to 22 carbons, 18 to 20 carbons, 20 to 24 carbons, such as C₁₂ alkyl, C₁₃ alkyl, C₁₄ alkyl, C₁₅ alkyl, C₁₆ alkyl, C₁₇ alkyl, C₁₈ alkyl, C₁₉ alkyl, C₂₀ alkyl, C₂₁ alkyl, C₂₂ alkyl, C₂₃ alkyl, or C₂₄ alkyl). The cation, X¹, can be, for example, a cation with a +1 or +2 charge. Suitable examples of X¹ include a Group I cation (e.g., sodium cation, potassium cation), a Group II cation (e.g., magnesium cation, calcium cation), an ammonium cation, or any combination thereof. In some aspects, X¹ is Group I cation, such as a sodium cation.

In an aspect, the solid MES comprises a compound in which R¹ is a C₁₆-C₁₈ alkyl and X¹ is a cation that balances the charge (e.g., sodium cation). In some aspects, R¹ is a C₁₆-C₁₈ alkyl, in which about 75-85% of the alkyl chains are C₁₆ and about 15-25% of the alkyl chains are Cis. In an aspect, the solid MES comprises a compound in which R¹ is a C₁₂-C₂₄ alkyl, in which about 80-85% of the alkyl chains are C₁₆, about 15-20% of the alkyl chains are Cis, about 0-3% of the alkyl chains are C₁₂-C₁₄, and a maximum of about 1% of the alkyl chains are C₂₀-C₂₄, and X¹ is a cation that balances the charge (e.g., sodium cation).

In some aspects, the solid cocoyl isethionate is of the formula R²C(O)OCH₂CH₂SO₃X², wherein R² is a C₇-C₁₇ alkyl and X² is a cation that balances the charge. The C₇-C₁₇ alkyl group is an alkyl comprising 7 to 17 carbons (e.g., 7 to 16 carbons, 7 to 14 carbons, 7 to 12 carbons, 8 to 17 carbons, 8 to 16 carbons, 10 to 17 carbons, 10 to 16 carbons, 12 to 17 carbons, or 12 to 16 carbons, such as C₇ alkyl, C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, or C₁₇ alkyl). The cation, X², can be, for example, a cation with a +1 or +2 charge. Suitable examples of X² include a Group I cation (e.g., sodium cation, potassium cation), a Group II cation (e.g., magnesium cation, calcium cation), an ammonium cation, or any combination thereof. In some aspects, X² is Group I cation, such as a sodium cation. In an aspect, the solid cocoyl isethionate comprises a compound in which R² is a C₁₂-C₁₇ alkyl or a C₁₆-C₁₇ alkyl, and X² is a cation that balances the charge (e.g., sodium cation).

In some aspects, the solid MES, solid cocoyl isethionate, or a combination thereof can be present in an amount from about 5 wt % to about 20 wt % (e.g., about 5 wt % to about 18 wt %, about 5 wt % to about 15 wt %, about 5 wt % to about 12 wt %, about 5 wt % to about 10 wt %, about 10 wt % to about 20 wt %, about 10 wt % to about 18 wt %, about 10 wt % to about 15 wt %, about 12 wt % to about 20 wt %, about 12 wt % to about 18 wt %, about 12 wt % to about 17 wt %, about 13 wt % to about 17 wt %, about 13 wt % to about 15 wt %, about 14 wt % to about 15 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, or about 20 wt %, of the total weight of the solid composition. In a particular aspect, the solid composition comprises about 5 wt %, about 12 wt %, or about 15 wt % of solid MES, solid cocoyl isethionate, or a combination thereof.

In some aspects, the solid composition comprises a solid flow aid to keep the solid composition from caking or lumping. In an aspect, a suitable flow aid includes an inert solid that can absorb water. Examples of flow aids include, for example, a chloride, a bromide, an iodide, a fluoride, a nitrate, a nitrite, a sulfate, a sulfite, a sulfide, a phosphate (e.g., sodium orthophosphate), a phosphide, a carbonate, a bicarbonate, a citrate, silica, calcium oxide, a silicate (e.g., sodium silicate, sodium aluminosilicate, aluminium calcium silicate, calcium silicate, magnesium silicate), an aluminate, a stearate (e.g., magnesium stearate), clay, flour, fly ash, starch, a zeolite, or any combination thereof. Flow aids in the form of salts can include one or more suitable counterions, such as a Group I cation (e.g., sodium cation, potassium cation), a Group II cation (e.g., magnesium cation, calcium cation), an ammonium cation, or any combination thereof. In an aspect, the solid composition comprises sodium chloride, sodium citrate, sodium carbonate, or any combination thereof as a flow aid.

In some aspects, the solid composition comprises from about 10 wt % to about 70 wt % of a solid flow aid relative to the total weight of the solid composition. For example, the solid flow aid can be present in an amount from about 10 wt % to about 60 wt %, about 10 wt % to about 50 wt %, 10 wt % to about 40 wt %, about 10 wt % to about 30 wt %, about 10 wt % to about 20 wt %, about 15 wt % to about 70 wt %, about 15 wt % to about 60 wt %, about 15 wt % to about 50 wt %, 15 wt % to about 40 wt %, about 15 wt % to about 30 wt %, about 15 wt % to about 20 wt %, about 20 wt % to about 70 wt %, about 20 wt % to about 60 wt %, about 20 wt % to about 50 wt %, 20 wt % to about 40 wt %, about 20 wt % to about 30 wt %, about 30 wt % to about 70 wt %, about 30 wt % to about 60 wt %, about 30 wt % to about 50 wt %, 30 wt % to about 40 wt %, about 40 wt % to about 70 wt %, about 40 wt % to about 60 wt %, about 40 wt % to about 50 wt %, about 50 wt % to about 70 wt %, about 50 wt % to about 60 wt %, about 60 wt % to about 70 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, or about 70 wt % of the total weight of the solid composition.

In an aspect, the solid composition further comprises an additive, such as an anti-redeposition agent, at least one enzyme, at least one chelating agent, and any combination thereof.

In some aspects, the solid composition comprises an anti-redeposition agent that keeps dissolved soil stains stable in the wash water and prevent the stains from redepositing on a textile. In some aspects, the anti-redeposition polymer is biodegradable. The anti-redeposition polymer can be based on acrylic acid, e.g., a homopolymer of acrylic acid, a polycarboxylate based on acrylic acid, a copolymer of acrylic acid and polystyrene, or a copolymer of maleic acid and acrylic acid. Examples of a suitable anti-redeposition polymer include, e.g., sodium polyacrylate, modified polyethylene glycol, styrene-acrylic acid copolymer, polyethyleneimine, or a combination thereof. In some aspects, the anti-redeposition polymer comprises sodium polyacrylate.

In some aspects, the solid composition comprises from about 0.001 wt % to about 5 wt % of an anti-redeposition polymer relative to the total weight of the solid composition. For example, the anti-redeposition polymer can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the solid composition.

In some aspects, the solid composition comprises at least one enzyme to aid in removing stains, including protein stains, oil stains, tannin stains, starch stains, and dyes. For example, a protease is capable of breaking down protein-based stains, such as sweat, blood, mud, and dairy products. An amylase is capable of breaking down a starch-based stain, such as cornstarch or potato starch. A lipase is capable of breaking down fats. A mannanase is capable of breaking down guar and locust bean stains. In some aspects, the at least one enzyme is a hydrolytic enzyme. The at least one enzyme can comprise a protease, an amylase, a mannanase, a lactase, a lipase, a perhydrolase, an oxidoreductase, an endocellulase, an exocellulase, or a combination thereof. In some aspects, the solid composition comprises a protease, an amylase, a mannanase, or a combination thereof.

In some aspects, the solid composition comprises a total from about 0.01 wt % to about 5 wt % of at least one enzyme (e.g., a protease, an amylase, a mannanase, or a combination thereof) relative to the total weight of the solid composition. For example, the total enzyme content can be from about 0.01 wt % to about 4 wt %, about 0.01 wt % to about 3 wt %, about 0.01 wt % to about 2 wt %, about 0.01 wt % to about 1 wt %, about 0.05 wt % to about 5 wt %, about 0.05 wt % to about 4 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.5 wt % to about 5 wt %, about 0.5 wt % to about 3 wt %, about 0.5 wt % to about 2 wt %, about 0.5 wt % to about 1 wt %, about 1 wt % to about 5 wt %, about 1 wt % to about 4 wt %, about 1 wt % to about 3 wt %, about 1 wt % to about 2 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.2 wt %, about 4.5 wt %, about 4.8 wt %, or about 5 wt % of the total weight of the solid composition.

In some aspects, the solid composition comprises a chelating agent (i.e., a chelant) that serves to improve the cleaning action of the detergent by scavenging metal ions naturally found in water. Suitable examples of a chelating agent include, e.g., citric acid, oxalic acid, nitriloacetic acid, phosphoric acid, polyphosphoric acid (e.g., a polyphosphate, such as tripolyphosphate), a phosphonate, ethylenediaminetetraacetic acid, diethylenetriaminepentaacetic acid, hydroxyethylethylenediaminetriacetic acid, glutamic acid, aspartic acid, iminodisuccinic acid, any salt thereof (e.g., sodium citrate, disodium edetate, tetrasodium glutamate diacetate, tetrasodium aspartate diacetate, tetrasodium iminodisuccinate), or any combination thereof. In some aspects, the solid composition comprises iminodisuccinic acid and/or tetrasodium iminodisuccinate.

In some aspects, the solid composition comprises from about 0.001 wt % to about 5 wt % of a chelating agent relative to the total weight of the solid composition. For example, the chelating agent can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the solid composition.

In an aspect, the solid composition can be a compact solid or in the form of loose particles. In an aspect, the solid composition is in the form of a powder or granule. In an aspect, a powder refers to fine particles, whereas granules are typically larger (e.g., moderately coarse and/or coarse) particles. Fine powder particles can have, for example, an average diameter of about 200 μm or less (e.g., about 180 μm or less, about 150 μm or less, about 125 μm or less, or about 100 μm or less). In some aspects, the powder particles can have an average diameter of about 90 μm to about 200 μm. Granule particles can have an average diameter of larger than 200 μm (e.g., about 300 μm or more, about 400 μm or more, or about 1000 μm or more). In some aspects, the granule particles can have an average diameter of more than 200 μm to about 1000 μm.

The liquid composition in the unit dose product comprises about 5 to about 20 wt % water relative to the liquid composition and a non-aqueous solvent. The liquid composition can further comprise at least one additive selected from surfactant, a base, an anti-redeposition agent, a performance polymer, a defoamer, an enzyme, a chelating agent, an optical brightener, a bitterant, a corrosion inhibitor, and any combination thereof.

The liquid composition comprises from about 5 wt % to about 20 wt % of water relative to the total weight of the liquid composition. For example, the water content can be from about 5 wt % to about 18 wt %, about 5 wt % to about 15 wt %, about 5 wt % to about 12 wt %, about 5 wt % to about 10 wt %, about 6 wt % to about 20 wt %, about 6 wt % to about 18 wt %, about 6 wt % to about 15 wt %, about 6 wt % to about 12 wt %, about 6 wt % to about 10 wt %, about 7 wt % to about 20 wt %, about 7 wt % to about 18 wt %, about 7 wt % to about 15 wt %, about 7 wt % to about 12 wt %, about 7 wt % to about 10 wt %, about 8 wt % to about 20 wt %, about 8 wt % to about 18 wt %, about 8 wt % to about 15 wt %, about 8 wt % to about 12 wt %, about 8 wt % to about 10 wt %, about 9 wt % to about 20 wt %, about 9 wt % to about 18 wt %, about 9 wt % to about 15 wt %, about 9 wt % to about 12 wt %, about 20 wt %, about 19 wt %, about 18 wt %, about 17 wt %, about 16 wt %, about 15 wt %, about 14 wt %, about 13 wt %, about 12 wt %, about 11 wt %, about 10 wt %, about 9 wt %, about 8 wt %, about 7 wt %, about 6 wt %, or about 5 wt % of the total weight of the liquid composition.

The liquid composition comprises at least one non-aqueous solvent in addition to water. In some aspects, the non-aqueous comprises an alcohol (e.g., a C₁₄ alcohol), a polyol (e.g., a diol, a triol, or higher, such as polyethylene glycol), or a combination thereof. Suitable examples of a solvent include, e.g., ethylene glycol, diethylene glycol, triethylene glycol, diethylene glycol monobutyl ether, propylene glycol, dipropylene glycol, tripropylene glycol, dipropylene glycol monobutyl ether, 1,3-butylene glycol, 1,4-butylene glycol, 1-(1-butoxy-2-propoxy)-2-propanol, 2-methyl-2,4-pentanediol, 1,5-pentanediol, 1,6-hexanediol, glycerin, polyethylene glycol, ethanol, or any combination thereof.

In some aspects, the at least one non-aqueous solvent comprises polyethylene glycol (PEG), which can have the structure:

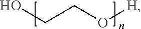

wherein n is an integer from 1 to 25 (e.g., 1 to 24, 1 to 23, 1 to 22, 1 to 21, 1 to 20, 1 to 18, 1 to 15, 1 to 12, 1 to 10, 2 to 25, 2 to 24 to 2 to 23, 2 to 22, 2 to 21, 2 to 20, 2 to 18, 2 to 15, 2 to 12, 2 to 10, 4 to 25, 4 to 23, 4 to 20, 4 to 18, 4 to 15, 4 to 12, 4 to 10, 7 to 25, 7 to 23, 7 to 20, 7 to 18, 7 to 15, 7 to 12, 7 to 10, 9 to 25, 9 to 23, 9 to 20, 9 to 18, 9 to 15, 9 to 12, etc.). In some aspects, n can be 1, 2, 3, 4, 5, 6, 7, 8, 9, 10, 11, 12, 13, 14, 15, 16, 17, 18, 19, 20, 21, 22, 23, 24, or 25.

In some aspects, the PEG has a molecular weight (including a number average molecular weight) of about 60 to about 1500 g/mol (e.g., about 60 to about 1200 g/mol, about 60 to about 1000 g/mol, about 100 to about 1500 g/mol, about 100 to about 1200 g/mol, about 100 to about 1000 g/mol, about 200 to about 1500 g/mol, about 200 to about 1200 g/mol, about 200 to about 1000 g/mol, about 300 to about 1500 g/mol, about 300 to about 1200 g/mol, about 300 to about 1000 g/mol, about 400 to about 1500 g/mol, about 400 to about 1200 g/mol, about 400 to about 1000 g/mol, about 200 g/mol, about 400 g/mol, about 600 g/mol, about 800 g/mol, or about 1000 g/mol). In some aspects, the PEG comprises PEG 400, which has a number average molecular weight of about 380 to about 420 g/mol.

In some aspects, the non-aqueous solvent comprises propylene glycol (PG). In some aspects, the non-aqueous solvent does not substantially comprise propylene glycol. In some aspects, the non-aqueous solvent comprises glycerin. In some aspects, the non-aqueous solvent comprises ethanol. In some aspects, the non-aqueous solvent comprises a combination of PEG, propylene glycol, glycerin, and ethanol. In some aspects, the non-aqueous solvent comprises a combination of PEG, glycerin, and ethanol.

In some aspects, the liquid composition comprises about 15 to about 70 wt % of non-aqueous solvent. For example, the total non-aqueous solvent content can be from about 15 wt % to about 65 wt %, about 15 wt % to about 60 wt %, about 15 wt % to about 55 wt %, about 15 wt % to about 50 wt %, about 15 wt % to about 45 wt %, about 15 wt % to about 40 wt %, about 15 wt % to about 35 wt %, about 15 wt % to about 30 wt %, about 15 wt % to about 25 wt %, about 15 wt % to about 20 wt %, about 20 to about 70 wt %, about 20 wt % to about 65 wt %, about 20 wt % to about 60 wt %, about 20 wt % to about 55 wt %, about 20 wt % to about 50 wt %, about 20 wt % to about 45 wt %, about 20 wt % to about 40 wt %, about 20 wt % to about 35 wt %, about 20 wt % to about 30 wt %, about 20 wt % to about 25 wt %, about 25 to about 70 wt %, about 25 wt % to about 65 wt %, about 25 wt % to about 60 wt %, about 25 wt % to about 55 wt %, about 25 wt % to about 50 wt %, about 25 wt % to about 45 wt %, about 25 wt % to about 40 wt %, about 25 wt % to about 35 wt %, about 25 wt % to about 30 wt %, about 30 to about 70 wt %, about 30 wt % to about 65 wt %, about 30 wt % to about 60 wt %, about 30 wt % to about 55 wt %, about 30 wt % to about 50 wt %, about 30 wt % to about 45 wt %, about 30 wt % to about 40 wt %, about 30 wt % to about 35 wt %, about 35 to about 70 wt %, about 35 wt % to about 65 wt %, about 35 wt % to about 60 wt %, about 35 wt % to about 55 wt %, about 35 wt % to about 50 wt %, about 35 wt % to about 45 wt %, about 35 wt % to about 40 wt %, about 40 to about 70 wt %, about 40 wt % to about 65 wt %, about 40 wt % to about 60 wt %, about 40 wt % to about 55 wt %, about 40 wt % to about 50 wt %, about 40 wt % to about 45 wt %, about 45 to about 70 wt %, about 45 wt % to about 65 wt %, about 45 wt % to about 60 wt %, about 45 wt % to about 55 wt %, about 45 wt % to about 50 wt %, about 50 to about 70 wt %, about 50 wt % to about 65 wt %, about 50 wt % to about 60 wt %, about 50 wt % to about 55 wt %, about 55 to about 70 wt %, about 55 wt % to about 65 wt %, about 55 wt % to about 60 wt %, about 60 to about 70 wt %, about 60 wt % to about 65 wt %, about 65 to about 70 wt %, about 70 wt %, about 68 wt %, about 65 wt %, about 62 wt %, about 60 wt %, about 58 wt %, about 55 wt %, about 54 wt %, about 53 wt %, about 52 wt %, about 51 wt %, about 50 wt %, about 49 wt %, about 48 wt %, about 47 wt %, about 46 wt %, about 45 wt %, about 44 wt %, about 43 wt %, about 42 wt %, about 41 wt %, about 40 wt %, about 39 wt %, about 38 wt %, about 37 wt %, about 36 wt %, about 35 wt %, about 34 wt %, about 33 wt %, about 32 wt %, about 31 wt %, about 30 wt %, about 29 wt %, about 28 wt %, about 27 wt %, about 26 wt %, about 25 wt %, about 24 wt %, about 23 wt %, about 22 wt %, about 21 wt %, about 20 wt %, about 19 wt %, about 18 wt %, about 17 wt %, about 16 wt %, or about 15 wt %, of the total weight of the liquid composition.

In some aspects, the non-aqueous solvent comprises about 5 wt % to about 35 wt % polyethylene glycol (e.g., PEG 400); about 10 wt % to about 25 wt % glycerin; and 0 wt % to about 10 wt % propylene glycol.

For example, polyethylene glycol (e.g., PEG 400) can be present in the liquid composition in an amount of about 5 wt % to about 35 wt %, about 5 wt % to about 30 wt %, about 5 wt % to about 25 wt %, about 5 wt % to about 20 wt %, about 5 wt % to about 15 wt %, about 5 wt % to about 10 wt %, about 10 wt % to about 35 wt %, about 10 wt % to about 30 wt %, about 10 wt % to about 25 wt %, about 10 wt % to about 20 wt %, about 10 wt % to about 15 wt %, about 15 wt % to about 35 wt %, about 15 wt % to about 30 wt %, about 15 wt % to about 25 wt %, about 15 wt % to about 20 wt %, about 20 wt % to about 35 wt %, about 20 wt % to about 30 wt %, about 20 wt % to about 25 wt %, about 25 wt % to about 35 wt %, about 25 wt % to about 30 wt %, about 30 wt % to about 35 wt %, about 35 wt %, about 34 wt %, about 33 wt %, about 32 wt %, about 31 wt %, about 30 wt %, about 29 wt %, about 28 wt %, about 27 wt %, about 26 wt %, about 25 wt %, about 24 wt %, about 23 wt %, about 22 wt %, about 21 wt %, about 20 wt %, about 19 wt %, about 18 wt %, about 17 wt %, about 16 wt %, about 15 wt %, about 14 wt %, about 13 wt %, about 12 wt %, about 11 wt %, about 10 wt %, about 9 wt %, about 8 wt %, about 7 wt %, about 6 wt %, or about 5 wt %, relative the total weight of the liquid composition.

For example, glycerin can be present in the liquid composition in an amount of about 10 wt % to about 25 wt %, about 10 wt % to about 20 wt %, about 10 wt % to about 15 wt %, about 15 wt % to about 25 wt %, about 15 wt % to about 20 wt %, about 20 wt % to about 25 wt %, about 25 wt %, about 24 wt %, about 23 wt %, about 22 wt %, about 21 wt %, about 20 wt %, about 19 wt %, about 18 wt %, about 17 wt %, about 16 wt %, about 15 wt %, about 14 wt %, about 13 wt %, about 12 wt %, about 11 wt %, or about 10 wt %, relative the total weight of the liquid composition.

For example, propylene glycol can be present in the liquid composition in an amount of 0 wt % to about 10 wt %, about 1 wt % to about 10 wt %, about 1 wt % to about 8 wt %, about 1 wt % to about 5 wt %, about 2 wt % to about 10 wt %, about 2 wt % to about 8 wt %, about 2 wt % to about 5 wt %, about 3 wt % to about 10 wt %, about 3 wt % to about 8 wt %, about 3 wt % to about 5 wt %, about 5 wt % to about 10 wt %, about 5 wt % to about 8 wt %, about 8 wt % to about 10 wt %, 0 wt % (i.e., the liquid composition is substantially free of propylene glycol), about 10 wt %, about 9 wt %, about 8 wt %, about 7 wt %, about 6 wt %, about 5 wt %, about 4 wt %, about 3 wt %, about 2 wt %, or about 1 wt %, relative the total weight of the liquid composition.

In some aspects, the non-aqueous solvent comprises about 5 wt % to about 35 wt % polyethylene glycol (e.g., PEG 400), about 10 wt % to about 25 wt % glycerin, and propylene glycol is not present.

In some aspects, the non-aqueous solvent comprises PEG, propylene glycol, and glycerin in a weight ratio of about (3-5):(0-1):1. In some aspects, the non-aqueous solvent comprises PEG, propylene glycol, and glycerin in a weight ratio of about 3:0:1, about 3.5:0:1, about 4:0:1, about 4.5:0:1, about 5:0:1, about 3:0.5:1, about 3.5:0.5:1, about 4:0.5:1, about 4.5:0.5:1, about 5:0.5:1, about 3:1:1, about 3.5:1:1, about 4:1:1, about 4.5:1:1, or about 5:1:1.

In some aspects, the liquid composition comprises at least one additive additive. For example, the at least one (e.g., 1, 2, 3, 4, 5, or 6, etc.) additive can be selected from surfactant, a base, an anti-redeposition agent, a performance polymer, a defoamer, an enzyme, a chelating agent, an optical brightener, a bitterant, a corrosion inhibitor, and any combination thereof.

In some aspects, the surfactant is an anionic surfactant, a cationic surfactant, a zwitterionic surfactant, a nonionic surfactant, or a combination thereof. For example, the liquid composition can comprise an anionic surfactant, a nonionic surfactant, or a combination of one or more thereof. In some aspects, the liquid composition comprises a combination of at least one anionic surfactant and at least one nonionic surfactant.

The anionic surfactant comprises a hydrophobic tail group (e.g., a linear aliphatic chain) and an anionic hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl), alkyl, or fluoro (e.g., perfluorinated). The anionic hydrophilic group can be, for example, a sulfate (—OSO₃⁻), sulfonate (—SO₃⁻), a phosphate (—OPO₃³⁻), a carboxylate (—C(O)O⁻), or the conjugate base of an organic acid. In some aspects, polyethylene glycol repeat units designated as “ether” can be disposed between the hydrophobic tail group (e.g., a fatty group) and hydrophilic head group.

In some aspects, the anionic surfactant comprises an alkyl sulfate, an alkyl sulfonate, a fatty acid salt, a bile acid salt, a glutamic acid salt, a cholic acid salt, a carboxylic poly(ethylene glycol) ether, a taurate, or a combination thereof. Typically, the salt will be a Group I (e.g., lithium, sodium, potassium, etc.), Group II (e.g., magnesium, calcium, etc.), or ammonium salt.

Examples of an alkyl sulfate include, e.g., a fatty sulfate (e.g., octylsulfate, decyl sulfate, lauryl (dodecyl) sulfate, myristyl sulfate), dioctyl sodium sulfosuccinate, and an alkyl ether sulfate (also called an alcohol ethoxysulfate)). Other examples of fatty sulfate include, e.g., 3-sulfopropyl ethoxylate laurylphenyl ether and coco (coconut fatty acid) sulfate. Examples of an alkyl sulfonate include, e.g., a linear alkylbenzene sulfonate (e.g., sodium laurylbenzene sulfonate), a perfluoroalkyl sulfonate (e.g., perfluorooctyl sulfonate, perfluorobutyl sulfonate), and a methyl ester sulfonate. Examples of a fatty acid salt include, e.g., a caprylate, a laurate, a palmitate, a myristate, and a stearate. Other anionic surfactants include a bile acid salt, a glutamic acid salt (e.g., N-myristoyl-l-glutamic acid), a glycolic acid salt, a cholic acid salt, a carboxylic poly(ethylene glycol) ether (e.g., glycolic acid ethoxylate laurylphenyl ether, glycolic acid ethoxylate oleyl ether), a taurate (e.g., sodium oleic acid methyl taurate, sodium coconut fatty acid methyl taurate, sodium cocyl methyl taurate), or any combination thereof.

In some aspects, the anionic surfactant comprises an alkyl ether sulfate (AES). In general, the AES will have the structure R⁴—O-(EO)ₙSO₃⁻X⁺, in which R⁴ is a C₈-C₁₈ alkyl group (linear or branched), EO is polyethoxylate, n is typically 1 to 8 (e.g., 1, 2, 3, 4, 5, 6, 7, or 8), and X⁺ is a cation that balances the charge of the sulfonate. The C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, or C₁₈ alkyl). In some aspects, the cation X⁺ can be a Group I cation, such as sodium cation or potassium cation, particularly sodium cation. In some aspects, the AES is sodium laureth sulfate.

In some aspects, the anionic surfactant comprises a linear alkylbenzene sulfonate (LAS). In some aspects, the LAS in the liquid composition is of Formula (I).

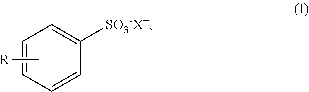

in which R is a linear C₁₀-C₁₈ (e.g., C₁₀, C₁₁, C₁₂, C₁₃, C₁₄, C₁₅, C₁₆, C₁₇, and C₁₈) alkyl, and X⁺ is a cation that balances the charge of the sulfonate. The phenylsulfonate can be at any suitable position (e.g., at the 1-position, 2-position, 3-position, 4-position, 5-position, 6-position, 7-position, 8-position, or 9-position) on the alkyl R. With respect to the benzene ring, the alkyl R and sulfonate can be ortho, meta, or para to each other. In some aspects, the alkyl R and sulfonate are para to one another.

In some aspects, the liquid composition does not comprise or is substantially free of a linear alkylbenzene sulfonate (LAS).

In some aspects, the anionic surfactant comprises an alkyl sulfate (e.g., a lauryl sulfate), a coco fatty acid, a linear alkylbenzene sulfonate, an alkyl ether sulfate, a methyl ester sulfonate, or a combination thereof. In some aspects, the anionic surfactant comprises a linear alkylbenzene sulfonate, an alcohol ethoxysulfate, a methyl ester sulfonate, or a combination thereof.

A cationic surfactant comprises a hydrophobic tail group (e.g., a linear aliphatic chain) and a cationic hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The cationic hydrophilic group can be, for example, an amino group that can be quaternized, such as trialkylammonium. The counterion can be any suitable anion that can balance the charge. In some aspects, the counterion is an anion with a −1 charge (e.g., X⁻), such as a halide (e.g., chloride, bromide, etc.), hydroxy, or tosylate.

In some aspects, the cationic surfactant can be a fatty amine salt or a quaternary ammonium compound. In some aspects, the cationic surfactant comprises a fatty amine salt, a fatty diamine salt, a coco amine alkoxylate, an alkoxylated amine, an alkoxylated diamine, fatty quaternary ammonium compound, a fatty amide quaternary ammonium compound, an alkoxylated quaternary ammonium compound, a benzalkyl quaternary ammonium compound, or any combination thereof. Examples of the fatty amine salt include, e.g., a C₈-C₁₈ fatty amine salt (e.g., R⁵—NH₃⁺, in which R⁵ is a C₈-C₁₈ alkyl group). Examples of a fatty diamine salt include, e.g., R⁵—NH₂⁺—R⁶—NH₃⁺, in which R⁵ is a C₈-C₁₈ alkyl group and R⁶ is a C₁₋₆ alkyl. Examples of an alkoxylated amine and an alkoxylated diamine include a polyethoxylated fatty amine and diamine, respectively. Examples of a fatty quaternary ammonium compound include, e.g., R⁷—NR⁸₃⁺, in which R⁷ is a C₈-C₁₈ alkyl group and each R⁸ is a C₁₋₄ alkyl, phenyl, or benzyl (e.g., alkyltrimethylammonium halide, alkyltrimethylammonium tosylate, alkyltrimethylammonium hydroxide). Examples of a fatty amide quaternary ammonium compound include, e.g., R⁹—C(O)N—R¹⁰—NR¹¹₃⁺, in which R⁹ is a C₈-C₁₈ alkyl group, R¹⁰ is a C₁₋₆ alkyl, and each R¹¹ is a C₁₋₄ alkyl, phenyl, or benzyl (e.g., trimethylammonium stearamide). Examples of an alkoxylated quaternary ammonium compound include, e.g., a polyethoxylated quaternary ammonium compound. Examples of a benzalkyl quaternary ammonium compound include, e.g., benzyl-C₈-C₁₈ alkyldimethylammonium (e.g., benzalkonium chloride). In any of the foregoing examples, the C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, or C₁₅ alkyl).

In some aspects, the cationic surfactant can be alkoxylated, in which polyalkylene glycol (e.g., polyethylene glycol, polypropylene glycol) repeat units can be disposed between the hydrophobic tail group (e.g., a fatty group) and hydrophilic head group.

The zwitterionic surfactant is amphoteric and comprises a hydrophobic tail group (e.g., a linear aliphatic chain) and a hydrophilic head group with both a cationic charge and an anionic charge. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The cationic moiety can be, for example, a quaternary ammonium group, such as dialkylammonium or trialkylammonium (e.g., C₁-C₄ alkyl, such as methyl). The anionic moiety can be, for example, oxo (O⁻), a sulfate (—OSO₃⁻), sulfonate (—SO₃⁻), a phosphate (—OPO₃³⁻), a carboxylate (—C(O)O⁻), or the conjugate base of an organic acid.

In some aspects, the zwitterionic surfactant comprises a betaine, a sulfonated quaternary ammonium compound, a phosphonated quaternary ammonium compound, a trialkylamine N-oxide, or any combination thereof.

Examples of a betaine include, e.g., C₈-C₁₈ alkyl betaine, cocobetaine, cocamidopropyl betaine, amidosulfobetaine-16, hexadecyl hydroxypropyl sulfobetaine, lauryl-N,N-(dimethylammonio)butyrate, and lauryl-N,N-(dimethyl)-glycinebetaine. Examples of a sulfonated quaternary ammonium compound include, e.g., 3-(N,N-dimethyl-octylammonio)propanesulfonate, 4-(N,N-dimethyl-dodecylammonio)butanesulfonate, 3-{N,N-dimethyl-N-[3-(4-octylbenzoylamino)propyl]ammonio}propanesulfonate, 3-[(3-cholamidopropyl)dimethylammonio]-1-propanesulfonate, 3-([3-cholamidopropyl]dimethylammonio)-2-hydroxy-1-propanesulfonate, coco(amidopropyl)dimethylammonio-2-hydroxypropanesulonate, lauryl-N,N-(dimethylammonio)butyrate, lauryl-N,N-(dimethyl)-propanesulfonate, 3-(4-tert-butyl-1-pyridinio)-1-propanesulfonate, 3-(1-pyridinio)-1-propanesulfonate, and 3-(benzyl-dimethylammonio)propanesulfonate. Examples of a phosphonated quaternary ammonium compound include, e.g., a phosphocholine, such as N-dodecylphosphocholine and hexadecyl phosphocholine. Examples of a trialkylamine N-oxide include, e.g., R⁴—N(O—)R⁵₂⁺, in which R⁴ is a C₈-C₁₈ alkyl group, R⁵ is a C₁₋₄ alkyl, such as lauryldimethylamine N-oxide and 4-ethyl-N,N-2-trimethyloctan-1-amine oxide.

A nonionic surfactant comprises a hydrophobic tail group (e.g., a linear aliphatic chain) and an uncharged (i.e., neutral) hydrophilic head group. The hydrophobic tail group can be a C₈-C₁₈ aliphatic (“fatty”) group that contains 0 or 1 double bond and can be optionally substituted with one or more (e.g., 1, 2, 3, or 4) substituents selected from an aryl group (e.g., phenyl, benzyl, naphthyl) or alkyl. The uncharged hydrophilic group can be, for example, an alkoxylate, such as ethoxylate ((—CH₂CH₂O—)ₙ; EO or PEO) or propoxylate ((—CH(CH₃)CH₂O—)ₘ; PO or PPO), in which n and m are the same or different and each is an integer of 1 to 100 (e.g., 1 to 90, 1 to 80, 1 to 70, 1 to 60, 1 to 50, 1 to 40, 1 to 30, 1 to 20, 1 to 15, 1 to 14, 1 to 13, to 13, 1 to 12, 1 to 11, 1 to 10, 1 to 9, 1 to 8, 1 to 7, 1 to 6, 1 to 5, or 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100).

In some aspects, the nonionic surfactant comprises a methyl ester ethoxylate, an alcohol alkoxylate, a fatty acid alkoxylate, an alkyl phenol ethoxylate, an alkoxylated amine, an alkyl glucoside, a fatty amide alkoxylate, a diester of alkoxylated fatty acid, a glycerol fatty ester, castor oil alkoxylate, an ethylene oxide-propylene oxide block copolymer, a phenol alkoxylate, or a combination thereof.

Examples of an alcohol alkoxylate include, e.g., C₈-C₁₈ ethoxylate and C₈-C₁₈ propoxylate. Examples of a fatty acid alkoxylate include, e.g., R¹²—C(O)O-EO-H, in which R¹² is a C₈-C₁₈ alkyl group and EO is polyethoxylate. Examples of an alkyl phenol ethoxylate include, e.g., R¹²-phenyl-O(EO)—H, in which R¹² is a C₈-C₁₈ alkyl group and EO is polyethoxylate. Examples of an alkoxylated amine include, e.g., ethoxylated C₈-C₁₈ alkylamine, tallow amine ethoxylate, lauryl amine ethoxylate ether, 2-2-(2-hydroxyethoxy)ethylaminoethanol, bis(hydroxyethoxyethyl)amine, 2,2′-((2-(2-hydroxyethoxy)ethyl)azanediyl)diethanol, and coco bis(2-hydroxyethyl) amine. Example of an alkyl glucoside include, e.g., alkyl polyglucoside, such as C₈-C₁₈ polyglucoside which can include 1 to 3 glucoside units. Examples of a fatty amide alkoxylate include R¹³—C(O)NH-(EO)—H, in which R¹³ is a C₈-C₁₈ alkyl group and EO is polyethoxylate. Examples of a diester of alkoxylated fatty acid include, e.g., R¹⁴—C(O)O-EO—C(O)—R^{14′}, in which R¹⁴ and R^{14′} is a C₈-C₁₈ alkyl group and EO is polyethoxylate. Examples of an alkoxylated methyl ester of fatty acid (e.g., a methyl ester ethoxylate) include e.g., R¹¹—C(O)O-EO-R¹⁶, in which R¹⁵ is a C₈-C₁₅ alkyl group, R¹⁶ is a C₁-C₄ alkyl group, and EO is polyethoxylate. Examples of a glycerol fatty ester include, e.g., an ester formed from glycerol and a fatty acid (e.g., C₈-C₁₈ alkyl), such as 2-ethylhexyl oleate, glycerol trioleate, glyceryl monooleate, glyceryl monotallate, n-butyl stearate, neopentylglycol dioleate, pentaerythritol monooleate, pentaerythritol tetraoleate, and trimethylolpropane trioleate. An example of a castor oil alkoxylate is polyethoxylated castor oil. Examples of an ethylene oxide-propylene oxide block copolymer include, e.g., R¹⁷O-(EO)ₙ—(PO)ₘ-(EO)ₙ—R¹⁸, in which R¹⁷ and R¹⁸ are the same or different and each is a C₁-C₇ alkyl, a C₅-C₆ cycloalkyl, or an aryl; n is an integer of 30-150 (e.g., about 40-135, about 42-133), and m is an integer of about 10-100 (e.g., about 10-80, about 20-70, about 21-68) and block copolymers such as, PEO—PPO-PEO and PPO-PEO-PPO. Examples of a phenol alkoxylate include, e.g., R⁵—C₆H₄-(EO)—H, wherein R⁵ is hydrogen or a C₁-C₁₅ alkyl group, and EO is polyethoxylate, such as octyphenol ethoxylate, nonylphenol ethoxylate, 2-phenoxydecan-1-ol, bisphenol ethoxylate, and a styrenated phenol ethoxylate (e.g., tristyrylphenol ethoxylate). In any of the foregoing examples, the C₈-C₁₈ alkyl group is an alkyl comprising 8 to 18 carbons (e.g., 8 to 16 carbons, 10 to 18 carbons, 10 to 16 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, or C₁₈ alkyl).

In general, the alcohol ethoxylate (AE) will have a chemical structure of formula (I):

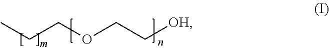

in which m is an integer of 10 to 16 (e.g., 10, 11, 12, 13, 14, 15, or 16) to form a C₁₂-C₁₈ fatty alkyl (e.g., C₁₂, C₁₃, C₁₄, Cis, C₁₆, C₁₇, and C₁₈), and n is an integer of 1 to 15 (e.g., 1, 2, 3, 4, 5, 6, 7, 8, 9, 10, 11, 12, 13, 14, or 15). The alcohol ethoxylate typically will contain a range of alkyl groups, such as C₁₂-C₁₅ or C₁₂-C₁₄ and can contain branches. In some aspects, the fatty alcohol ethoxylate can contain 1 to 15 moles (e.g., 1 to 12 moles, 1 to 9 moles, 1 to 7 moles, or about 7 moles) of ethoxylate per mole of alcohol. In some aspects, the fatty alcohol ethoxylate can be a C₁₂-C₁₈ fatty alcohol ethoxylate with 1-15 moles of ethoxylate. In some aspects, the fatty alcohol ethoxylate comprises a C₁₂-C₁₅ fatty alcohol ethoxylate with 7 moles of ethoxylate. In some aspects, the alcohol ethoxylate comprises ethoxylated lauryl alcohol.

In some aspects, the methyl ester ethoxylate (MEE) can be of the formula: R¹⁹—C(═O)O-(EO)ₙ—CH₃, wherein R¹⁹ is a C₈-C₂₄ alkyl group, EO is polyethoxylate, and n is an integer of moles from 5 to 30 (i.e., n is 5, 6, 7, 8, 9, 10, 11, 12, 13, 14, 15, 16, 17, 18, 19, 20, 21, 22, 23, 24, 25, 26, 27, 28, 29, or 30). The C₈-C₂₄ alkyl group is an alkyl comprising 8 to 24 carbons (e.g., 8 to 22 carbons, 8 to 20 carbons, 8 to 18 carbons, 8 to 16 carbons, 10 to 24 carbons, 10 to 22 carbons, 10 to 20 carbons, 10 to 18 carbons, 10 to 16 carbons, 12 to 24 carbons, 12 to 22 carbons, 12 to 20 carbons, 12 to 18 carbons, 12 to 16 carbons, such as C₈ alkyl, C₉ alkyl, C₁₀ alkyl, C₁₁ alkyl, C₁₂ alkyl, C₁₃ alkyl, C₁₄ alkyl, C₁₅ alkyl, C₁₆ alkyl, C₁₇ alkyl, C₁₈ alkyl, C₁₉ alkyl, C₂₀ alkyl, C₂₁ alkyl, C₂₂ alkyl, C₂₃ alkyl, or C₂₄ alkyl). In some aspects, the MEE is of formula R¹⁹—C(═O)O-(EO)ₙ—CH₃, in which R¹⁹ is C₁₇ alkyl, and n is 10.

In some aspects, the liquid composition comprises an alcohol ethoxylate (AE), an alkyl ether sulfate (AES), a methyl ester ethoxylate, a coco fatty acid, an alkyl polyglucoside, or any combination thereof. In some aspects, the liquid composition comprises an alcohol ethoxylate (AE) and an alkyl ether sulfate (AES). In some of these aspects, the liquid composition comprises an alcohol ethoxylate (AE) and an alkyl ether sulfate (AES) and does not comprise (e.g., is substantially free of) a linear alkylbenzene sulfonate.

In some aspects, the liquid composition comprises from about 10 wt % to about 65 wt % of a surfactant (e.g., an alcohol ethoxylate (AE), an alkyl ether sulfate (AES), a methyl ester ethoxylate, a coco fatty acid, an alkyl polyglucoside, or any combination thereof) relative to the total weight of the liquid composition. For example, the total surfactant content can be from about 10 wt % to about 60 wt %, about 10 wt % to about 58 wt %, about 10 wt % to about 55 wt %, about 10 wt % to about 52 wt %, about 10 wt % to about 50 wt %, about 10 wt % to about 48 wt %, about 10 wt % to about 45 wt %, about 10 wt % to about 42 wt %, about 10 wt % to about 40 wt %, about 10 wt % to about 35 wt %, about 10 wt % to about 30 wt %, about 10 wt % to about 25 wt %, about 10 wt % to about 20 wt %, about 10 wt % to about 18 wt %, about 10 wt % to about 15 wt %, about 15 wt % to about 65 wt %, about 15 wt % to about 60 wt %, about 15 wt % to about 58 wt %, about 15 wt % to about 55 wt %, about 15 wt % to about 52 wt %, about 15 wt % to about 50 wt %, about 15 wt % to about 48 wt %, about 15 wt % to about 45 wt %, about 15 wt % to about 42 wt %, about 15 wt % to about 40 wt %, about 15 wt % to about 35 wt %, about 15 wt % to about 30 wt %, about 15 wt % to about 25 wt %, about 15 wt % to about 20 wt %, about 15 wt % to about 18 wt %, about 20 wt % to about 65 wt %, about 20 wt % to about 60 wt %, about 20 wt % to about 58 wt %, about 20 wt % to about 55 wt %, about 20 wt % to about 52 wt %, about 20 wt % to about 50 wt %, about 20 wt % to about 48 wt %, about 20 wt % to about 45 wt %, about 20 wt % to about 42 wt %, about 20 wt % to about 40 wt %, about 20 wt % to about 35 wt %, about 20 wt % to about 30 wt %, about 20 wt % to about 25 wt %, about 25 wt % to about 65 wt %, about 25 wt % to about 60 wt %, about 25 wt % to about 58 wt %, about 25 wt % to about 55 wt %, about 25 wt % to about 52 wt %, about 25 wt % to about 50 wt %, about 25 wt % to about 48 wt %, about 25 wt % to about 45 wt %, about 25 wt % to about 42 wt %, about 25 wt % to about 40 wt %, about 25 wt % to about 35 wt %, about 25 wt % to about 30 wt %, about 28 wt % to about 65 wt %, about 28 wt % to about 60 wt %, about 28 wt % to about 58 wt %, about 28 wt % to about 55 wt %, about 28 wt % to about 52 wt %, about 28 wt % to about 50 wt %, about 28 wt % to about 48 wt %, about 28 wt % to about 45 wt %, about 28 wt % to about 42 wt %, about 28 wt % to about 40 wt %, about 28 wt % to about 35 wt %, about 28 wt % to about 30 wt %, about 30 wt % to about 65 wt %, about 30 wt % to about 60 wt %, about 30 wt % to about 58 wt %, about 30 wt % to about 55 wt %, about 30 wt % to about 52 wt %, about 30 wt % to about 50 wt %, about 30 wt % to about 48 wt %, about 30 wt % to about 45 wt %, about 30 wt % to about 42 wt %, about 30 wt % to about 40 wt %, about 30 wt % to about 35 wt %, about 32 wt % to about 65 wt %, about 32 wt % to about 60 wt %, about 32 wt % to about 58 wt %, about 32 wt % to about 55 wt %, about 32 wt % to about 52 wt %, about 32 wt % to about 50 wt %, about 32 wt % to about 48 wt %, about 32 wt % to about 45 wt %, about 32 wt % to about 42 wt %, about 32 wt % to about 40 wt %, about 32 wt % to about 35 wt %, about 35 wt % to about 60 wt %, about 35 wt % to about 58 wt %, about 35 wt % to about 55 wt %, about 35 wt % to about 52 wt %, about 35 wt % to about 50 wt %, about 35 wt % to about 48 wt %, about 35 wt % to about 45 wt %, about 35 wt % to about 42 wt %, about 35 wt % to about 40 wt %, about 38 wt % to about 65 wt %, about 38 wt % to about 60 wt %, about 38 wt % to about 58 wt %, about 38 wt % to about 55 wt %, about 38 wt % to about 52 wt %, about 38 wt % to about 50 wt %, about 38 wt % to about 48 wt %, about 38 wt % to about 45 wt %, about 38 wt % to about 42 wt %, about 38 wt % to about 40 wt %, about 40 wt % to about 65 wt %, about 40 wt % to about 60 wt %, about 40 wt % to about 58 wt %, about 40 wt % to about 55 wt %, about 40 wt % to about 52 wt %, about 40 wt % to about 50 wt %, about 40 wt % to about 48 wt %, about 40 wt % to about 45 wt %, about 40 wt % to about 42 wt %, about 42 wt % to about 65 wt %, about 42 wt % to about 60 wt %, about 42 wt % to about 58 wt %, about 42 wt % to about 55 wt %, about 42 wt % to about 52 wt %, about 42 wt % to about 50 wt %, about 42 wt % to about 48 wt %, about 42 wt % to about 45 wt %, about 45 wt % to about 65 wt %, about 45 wt % to about 60 wt %, about 45 wt % to about 58 wt %, about 45 wt % to about 55 wt %, about 45 wt % to about 52 wt %, about 45 wt % to about 50 wt %, about 45 wt % to about 48 wt %, about 48 wt % to about 65 wt %, about 48 wt % to about 60 wt %, about 48 wt % to about 58 wt %, about 48 wt % to about 55 wt %, about 48 wt % to about 52 wt %, about 48 wt % to about 50 wt %, about 50 wt % to about 65 wt %, about 50 wt % to about 60 wt %, about 50 wt % to about 58 wt %, about 50 wt % to about 55 wt %, about 50 wt % to about 52 wt %, about 52 wt % to about 65 wt %, about 52 wt % to about 60 wt %, about 52 wt % to about 58 wt %, about 52 wt % to about 55 wt %, about 55 wt % to about 65 wt %, about 55 wt % to about 60 wt %, about 55 wt % to about 58 wt %, about 58 wt % to about 65 wt %, about 58 wt % to about 60 wt %, about 60 wt % to about 65 wt %, about 65 wt %, about 64 wt %, about 63 wt %, about 62 wt %, about 61 wt %, about 60 wt %, about 59 wt %, about 58 wt %, about 57 wt %, about 56 wt %, about 55 wt %, about 54 wt %, about 53 wt %, about 52 wt %, about 51 wt %, about 50 wt %, about 49 wt %, about 48 wt %, about 47 wt %, about 46 wt %, about 45 wt %, about 44 wt %, about 43 wt %, about 42 wt %, about 41 wt %, about 40 wt %, about 39 wt %, about 38 wt %, about 37 wt %, about 36 wt %, about 35 wt %, about 34 wt %, about 33 wt %, about 32 wt %, about 31 wt %, about 30 wt %, about 29 wt %, about 28 wt %, about 27 wt %, about 26 wt %, about 25 wt %, about 24 wt %, about 23 wt %, about 22 wt %, about 21 wt %, about 20 wt %, about 19 wt %, about 18 wt %, about 17 wt %, about 16 wt %, about 15 wt %, about 14 wt %, about 13 wt %, about 12 wt %, about 11 wt %, or about 10 wt % of the total weight of the liquid composition.

In some aspects, the liquid composition comprises a base to adjust the pH. The base can be any suitable compound with a pKb of about 1 to about 13. In some aspects, the base can be monoethanolamine, diethanolamine, triethanolamine, methyl diethanolamine, a hydroxide, a tetraborate, a phosphate, a carbonate, a bicarbonate, or a combination thereof. The base can include a counterion, such as a Group I cation or Group II cation. In some aspects, the base is a Group I hydroxide, a Group II hydroxide, sodium tetraborate, trisodium phosphate, sodium carbonate, or a combination thereof. In some aspects, the base can be a monoethanolamine, sodium carbonate, or a Group I hydroxide (e.g., sodium hydroxide, potassium hydroxide, or a combination of both). In some aspects, the liquid composition comprises monoethanolamine.

In some aspects, the liquid composition comprises from about 0.1 wt % to about 15 wt % of base (e.g., a Group I hydroxide, sodium carbonate, monoethanolamine) relative to the total weight of the liquid composition. For example, the base can be present in an amount from about 0.1 wt % to about 12 wt %, about 0.1 wt % to about 10 wt %, about 0.5 wt % to about 15 wt %, about 0.5 wt % to about 12 wt %, about 0.5 wt % to about 10 wt %, about 1 wt % to about 15 wt %, about 1 wt % to about 14 wt %, about 1 wt % to about 13 wt %, about 1 wt % to about 12 wt %, about 1 wt % to about 11 wt %, about 1 wt % to about 10 wt %, about 1 wt % to about 9 wt %, about 1 wt % to about 8 wt %, about 1 wt % to about 5 wt %, about 1 wt % to about 3 wt %, about 1.5 wt % to about 15 wt %, about 1.5 wt % to about 10 wt %, about 1.5 wt % to about 8 wt %, about 1.5 wt % to about 5 wt %, about 1.5 wt % to about 3 wt %, about 2 wt % to about 15 wt %, about 2 wt % to about 10 wt %, about 2 wt % to about 8 wt %, about 2 wt % to about 5 wt %, about 2 wt % to about 3 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 11 wt %, about 12 wt %, about 13 wt %, about 14 wt %, or about 15 wt % of the total weight of the liquid composition. In some aspects, the liquid composition comprises from about 0.5 wt % to about 5 wt % or from about 1 to about 3 wt % of base. In some aspects, the liquid composition comprises not more than 2 wt % monoethanolamine.

In some aspects, the liquid composition comprises an anti-redeposition agent that keeps dissolved soil stains stable in the wash water and prevent the stains from redepositing on a textile. In some aspects, the anti-redeposition polymer is biodegradable. The anti-redeposition polymer can be based on acrylic acid, e.g., a homopolymer of acrylic acid, a polycarboxylate based on acrylic acid, a copolymer of acrylic acid and polystyrene, or a copolymer of maleic acid and acrylic acid. Examples of a suitable anti-redeposition polymer include, e.g., sodium polyacrylate, modified polyethylene glycol, styrene-acrylic acid copolymer, polyethyleneimine, or a combination thereof. In some aspects, the anti-redeposition polymer comprises sodium polyacrylate.

In some aspects, the liquid composition comprises from about 0.001 wt % to about 5 wt % of an anti-redeposition polymer relative to the total weight of the liquid composition. For example, the anti-redeposition polymer can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the liquid composition.

In some aspects, the liquid composition comprises a performance polymer that improves at least one aspect of a washed textile. In some aspects, the performance polymer improves the cleaning action of the unit dose product, removes or reduces stains, maintains whiteness, protects color, protects the integrity of a textile, provides odor control, or any combination thereof. In some aspects the performance polymer comprises polyethyleneimine ethoxylate, polyethyleneimine ethoxylate propoxylate, a polycarboxylate (e.g., an acrylic homopolymer or copolymer), carboxymethylcellulose, a polyester, polyvinyl pyrrolidone, a copolymer comprising terephthalic acid, a copolymer comprising maleic acid, a copolymer comprising acrylamino tertiary butyl sulfonate, or any combination thereof. In some aspects the performance polymer comprises an alkoxylated polyethyleneimine, such as polyethyleneimine ethoxylate, polyethyleneimine ethoxylate propoxylate, or a combination of both.

In some aspects, the liquid composition comprises from about 1 wt % to about 10 wt % of a performance polymer relative to the total weight of the liquid composition. For example, the performance polymer content can be from about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of the total weight of the liquid composition.

In some aspects, the liquid composition comprises a defoamer that helps maintain the rise of foam, which can, in some aspects, avoid high foaming or water spilling from a washing machine. In general, the defoamer has a low viscosity. In some aspects the defoamer comprises a coconut fatty acid, a silicone, ethylene-bis-stearamide, a fatty acid, a fatty alcohol, or any combination thereof. In an aspect, the defoamer is a coconut fatty acid.

In some aspects, the liquid composition comprises from about 1 wt % to about 18 wt % of a defoamer relative to the total weight of the composition. For example, the defoamer content can be from about 1 wt % to about 15 wt %, about 1 wt % to about 12 wt %, about 1 wt % to about 10 wt %, about 1 wt % to about 8 wt %, about 1 wt % to about 5 wt %, about 1 wt % to about 3 wt %, about 1.5 wt % to about 10 wt %, about 1.5 wt % to about 8 wt %, about 1.5 wt % to about 5 wt %, about 1.5 wt % to about 3 wt %, about 2 wt % to about 10 wt %, about 2 wt % to about 8 wt %, about 2 wt % to about 5 wt %, about 2 wt % to about 3 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 11 wt %, about 12 wt %, about 13 wt %, about 14 wt %, about 15 wt %, about 16 wt %, about 17 wt %, or about 18 wt %, of the total weight of the liquid composition. In some aspects, the liquid composition comprises from about 3 wt % to about 10 wt % of a defoamer (e.g., a coconut fatty acid) relative to the total weight of the liquid composition.

In some aspects, the liquid composition comprises an enzyme to aid in removing stains, including protein stains, oil stains, tannin stains, starch stains, and dyes. In some aspects, the enzyme is a hydrolytic enzyme. The enzyme can comprise a protease, an amylase, a mannanase, a lactase, a lipase, a perhydrolase, an oxidoreductase, an endocellulase, an exocellulase, or a combination thereof. In some aspects, the liquid composition comprises a protease, an amylase, a mannanase, or a combination thereof.

In some aspects, the liquid composition comprises a total from about 0.01 wt % to about 5 wt % of at least one enzyme (e.g., a protease, an amylase, a mannanase, or a combination thereof) relative to the total weight of the liquid composition. For example, the total enzyme content can be from about 0.01 wt % to about 4 wt %, about 0.01 wt % to about 3 wt %, about 0.01 wt % to about 2 wt %, about 0.01 wt % to about 1 wt %, about 0.05 wt % to about 5 wt %, about 0.05 wt % to about 4 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.5 wt % to about 5 wt %, about 0.5 wt % to about 3 wt %, about 0.5 wt % to about 2 wt %, about 0.5 wt % to about 1 wt %, about 1 wt % to about 5 wt %, about 1 wt % to about 4 wt %, about 1 wt % to about 3 wt %, about 1 wt % to about 2 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.2 wt %, about 4.5 wt %, about 4.8 wt %, or about 5 wt % of the total weight of the liquid composition.

In some aspects, the liquid composition comprises a chelating agent (i.e., a chelant) that serves to improve the cleaning action of the detergent by scavenging metal ions naturally found in water. Suitable examples of a chelating agent include, e.g., citric acid, oxalic acid, nitriloacetic acid, phosphoric acid, polyphosphoric acid (e.g., a polyphosphate, such as tripolyphosphate), a phosphonate, ethylenediaminetetraacetic acid, diethylenetriaminepentaacetic acid, hydroxyethylethylenediaminetriacetic acid, glutamic acid, aspartic acid, iminodisuccinic acid, any salt thereof (e.g., sodium citrate, disodium edetate, tetrasodium glutamate diacetate, tetrasodium aspartate diacetate, tetrasodium iminodisuccinate, trisodium ethylenediamine-N,N-disuccinate), and any combination thereof. In some aspects, the liquid composition comprises iminodisuccinic acid and/or tetrasodium iminodisuccinate.

In some aspects, the liquid composition comprises from about 0.001 wt % to about 5 wt % of a chelating agent relative to the total weight of the liquid composition. For example, the chelating agent can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the liquid composition.

In some aspects, the liquid composition comprises an optical brightener (e.g., a fluorescent whitening agent), which is any suitable hydrophilic compound that absorbs ultra violet light and emits visible (e.g., blue-violet) light to make textiles appear brighter. The optical brightener can comprise a triazole, a stilbene, or a biphenyl group. Examples of the optical brightener include, e.g., 2,2′-(2,5-thienediyl)bis[5-(2-methyl-2-propanyl)-1,3-benzoxazole, 5,5′-((perfluorocyclopent-1-ene-1,2-diyl)bis(5-methylthiophene-4,2-diyl))bis(2-(6-methoxybenzo[d]thiazol-2-yl)-1,3,4-oxadiazole), 5,5′-((perfluorocyclopent-1-ene-1,2-diyl)bis(5-methylthiophene-4,2-diyl))bis(2-(6-methoxybenzo[d]thiazol-2-yl)-1,3,4-oxadiazole), 2′,7′-bis(5-(4-(tert-butyl)phenyl)-1,3,4-oxadiazol-2-yl)-N³,N³,N⁶,N⁶-tetraphenyl-9,9′-spirobi[fluorene]-3,6-diamine, N,N-diphenyl-4-(5-(4-(triphenylsilyl)phenyl)-1,3,4-oxadiazol-2-yl)aniline, ((4-((4-(5-(4-nitrophenyl)-1,3,4-oxadiazol-2-yl)phenyl)diazenyl) phenyl)azanediyl)bis(ethane-2,1-diyl) diacetate, ((4-((4-(5-(4-((E)-4-nitrostyryl)phenyl)-1,3,4-oxadiazol-2-yl)phenyl)diazenyl)phenyl)azanediyl)bis(ethane-2,1-diyl) diacetate, 4,4′-diamino-2,2′-stilbenedisulfonic acid, 4,4′-bis(benzoxazolyl)-cis-stilbene, and 2,5-bis(benzoxazol-2-yl)thiophene, and combinations thereof. In some aspects, the optical brightener can be 2,2′-(2,5-thienediyl)bis[5-(2-methyl-2-propanyl)-1,3-benzoxazole.

In some aspects, the liquid composition can comprise from about 0.001 wt % to about 5 wt % of an optical brightener relative to the total weight of the liquid composition. For example, the optical brightener can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the liquid composition.

In some aspects, the liquid composition can comprise a bitterant (e.g., a bittering agent), which is any suitable compound that imparts a bitter taste to the liquid composition. The bitterant can be added to avoid accidental poisoning. Examples of the bitterant include, e.g., denatonium benzoate, sucrose octaacetate, quercetin, brucine, quassin, and combinations thereof. In an aspect, the bitterant can be denatonium benzoate.

In some aspects, the liquid composition can comprise from about 0.001 wt % to about 1 wt % of a bitterant relative to the total weight of the liquid composition. For example, the bitterant can be present in an amount from about 0.001 wt % to about 0.9 wt %, about 0.001 wt % to about 0.8 wt %, about 0.001 wt % to about 0.7 wt %, about 0.001 wt % to about 0.5 wt %, about 0.005 wt % to about 1 wt %, about 0.005 wt % to about 0.9 wt %, about 0.005 wt % to about 0.8 wt %, about 0.005 wt % to about 0.6 wt %, about 0.005 wt % to about 0.5 wt %, about 0.01 wt % to about 1 wt %, about 0.01 wt % to about 0.9 wt %, about 0.01 wt % to about 0.8 wt %, about 0.01 wt % to about 0.7 wt %, about 0.05 wt % to about 0.6 wt %, about 0.05 wt % to about 0.5 wt %, about 0.05 wt % to about 0.2 wt %, about 0.05 wt % to about 0.1 wt %, about 0.1 wt % to about 1 wt %, about 0.1 wt % to about 0.9 wt %, about 0.1 wt % to about 0.8 wt %, about 0.1 wt % to about 0.5 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt % of the total weight of the liquid composition.

In some aspects, the liquid composition comprises a corrosion inhibitor (e.g., an oxygen scavenger), which is any suitable compound that lowers the dissolved oxygen content in the washing medium by reacting with oxygen. The corrosion inhibitor can, for example, protect the inside of a washing machine from rusting. Examples of the corrosion inhibitor include, e.g., an inorganic corrosion inhibitor (e.g., a sulfite, a silicate, a polyphosphate, calcium hydroxide), an organic corrosion inhibitor (e.g., calcium hydrogen carbonate, a sulfonate, a phosphonate, a C₁₂-C₁₅ alcohol ether phosphate), or a combination thereof. In an aspect, the corrosion inhibitor can be sodium sulfite.

In some aspects, the liquid composition comprises from about 0.001 wt % to about 5 wt % of a corrosion inhibitor (e.g., an oxygen scavenger) relative to the total weight of the liquid composition. For example, the corrosion inhibitor can be present in an amount from about 0.001 wt % to about 4 wt %, about 0.001 wt % to about 3 wt %, about 0.001 wt % to about 2 wt %, about 0.001 wt % to about 1 wt %, about 0.005 wt % to about 5 wt %, about 0.005 wt % to about 4 wt %, about 0.005 wt % to about 3 wt %, about 0.005 wt % to about 2 wt %, about 0.005 wt % to about 1 wt %, about 0.01 wt % to about 5 wt %, about 0.01 wt % to about 3 wt %, about 0.01 wt % to about 2 wt %, about 0.01 wt % to about 1 wt %, about 0.05 wt % to about 5 wt %, about 0.05 wt % to about 3 wt %, about 0.05 wt % to about 2 wt %, about 0.05 wt % to about 1 wt %, about 0.1 wt % to about 5 wt %, about 0.1 wt % to about 3 wt %, about 0.1 wt % to about 2 wt %, about 0.1 wt % to about 1 wt %, about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 2 wt %, about 2.5 wt %, about 3 wt %, about 3.5 wt %, about 4 wt %, about 4.5 wt %, or about 5 wt % of the total weight of the liquid composition.

In some aspects, the liquid composition can have a pH of about 6.5 to about 10 (e.g., about 7 to about 10, about 7.5 to about 10, about 8 to about 10, about 8.5 to about 10, about 9 to about 10, about 9.5 to about 10, about 6.5 to about 9.5, about 7 to about 9.5, about 7.5 to about 9.5, about 8 to about 9.5, or about 8.5 to about 9.5, about 6.5 to about 9, about 7 to about 9, about 7.5 to about 9, about 8 to about 9, or about 8.5 to about 9). In some aspects, the liquid composition has a pH of about 6.5, about 6.6, about 6.7, about 6.8, about 6.9, about 7, about 7.1, about 7.2, about 7.3, about 7.4, about 7.5, about 7.6, about 7.7, about 7.8, about 7.9, about 8, about 8.1, about 8.2, about 8.3, about 8.4, about 8.5, about 8.6, about 8.7, about 8.8, about 8.9, about 9, about 9.1, about 9.2, about 9.3, about 9.4, about 9.5, about 9.6, about 9.7, about 9.8, about 9.9, or about 10. In some aspects, the liquid composition has a pH of about 7 to about 8. In some aspects, the liquid composition has a pH of about 8 to about 9.

In an aspect, a unit dose product comprises: a water-soluble film material comprising a first compartment and a second compartment;
the first compartment enclosing a liquid composition comprising
about 5 to about 20 weight percent (wt %) water relative to the liquid composition,
about 15 to about 70 wt % of a non-aqueous solvent, and
optionally an additive selected from surfactant, a base, an anti-redeposition agent, a performance polymer, a defoamer, an enzyme, a chelating agent, an optical brightener, a bitterant, a corrosion inhibitor, and any combination thereof; and
the second compartment enclosing a solid composition comprising
about 5 to about 30 wt % of a solid methyl ester sulfonate (MES) and/or a solid cocoyl isethionate and
about 10 wt % to about 70 wt % a solid flow aid.
   The amounts of each component will be selected to provide a liquid composition comprising 100 wt % of the total liquid composition and to provide a solid composition comprising 100 wt % of the total solid composition.

In an aspect of this unit dose product, the liquid composition further comprises at least one additive selected from surfactant, a base, an anti-redeposition agent, a performance polymer, a defoamer, an enzyme, a chelating agent, an optical brightener, a bitterant, a corrosion inhibitor, and any combination thereof, and/or the solid composition further comprises an additive selected from an anti-redeposition agent, enzyme, chelating agent, and any combination thereof.

In an aspect, the present disclosure relates to a unit dose product comprising:
a water-soluble film material comprising a first compartment and a second compartment;
the first compartment enclosing a liquid composition comprising
a non-aqueous solvent comprising polyethylene glycol and glycerin, and
a surfactant selected from an alcohol ethoxylate (AE), an alkyl ether sulfate (AES), a methyl ester ethoxylate, a coco fatty acid, an alkyl polyglucoside, and any combination thereof; and
the second compartment enclosing a powder composition comprising
a methyl ester sulfonate (MES) of the formula R¹CH(SO₃X¹)(C(═O)OCH₃), wherein R¹ is a C₁₂-C₂₄ alkyl and X¹ is a cation that balances the charge and/or
a cocoyl isethionate of the formula R²C(O)OCH₂CH₂SO₃X², wherein R² is a C₇-C₁₇ alkyl and X² is a cation that balances the charge and
a solid flow aid.

In an aspect of this unit dose product, R¹ is a C₁₆-C₁₈ alkyl and X¹ is a cation that balances the charge (e.g., Na⁺) of the methyl ester sulfonate (MES). In some aspects, R¹ is a C₁₆-C₁₈ alkyl, in which about 75-85% of the alkyl chains are C₁₆ and about 15-25% of the alkyl chains are Cis. In an aspect of this unit dose product, R¹ is a C₁₂-C₂₄ alkyl, in which about 80-85% of the alkyl chains are C₁₆, about 15-20% of the alkyl chains are C₁₈, about 0-3% of the alkyl chains are C₁₂-C₁₄, and a maximum of about 1% of the alkyl chains are C₂₀-C₂₄, and X¹ is a cation that balances the charge (e.g., Na⁺) of the MES.

In an aspect of this unit dose product, R² is a C₁₂-C₁₇ alkyl or a C₁₆-C₁₇ alkyl, and X² is a cation that balances the charge (e.g., Na⁺) of the cocoyl isethionate.

In an aspect of this unit dose product, the non-aqueous solvent comprises about 5 to about 35 wt % polyethylene glycol, 0 wt % to about 10 wt % propylene glycol, and about 10 to about 25 wt % glycerin.

The unit dose product can contain any suitable amount of the liquid and solid compositions. In some aspects, the liquid composition is in a greater amount than the solid composition in the unit dose product. In other aspects, the solid composition is in a greater amount than the liquid composition in the unit dose product. In an aspect, the liquid composition is about 10 to about 30 grams (e.g., about 10 to about 25 grams, about 10 to about 20 grams, about 12 to about 30 grams, about 12 to about 25 grams, about 12 to about 20 grams, about 15 to about 30 grams, about 15 to about 25 grams, or about 15 to about 20 grams). In some aspects, the solid composition is about 1 to about 10 grams (e.g., about 1 to about 9 grams, about 1 to about 8 grams, about 1 to about 7 grams, about 1 to about 6 grams, about 1 to about 5 grams, about 1 to about 4 grams, or about 1 to about 3 grams). In some aspects, the weight ratio of liquid composition to solid composition is about 3:1 to about 20:1 (e.g., about 3:1, about 4:1, about 5:1, about 6:1, about 7:1, about 8:1, about 9:1, about 10:1, about 11:1, about 12:1, about 13:1, about 14:1, about 15:1, about 16:1, about 17:1, about 18:1, about 19:1, or about 20:1). In some aspects, the weight ratio of liquid composition to solid composition is about 5:1 to about 20:1 or about 3:1 to about 12:1.

The unit dose product comprises at least two compartments, in which a first compartment is adjacent to a second compartment and the first and second compartments are separated by at least one layer of the film. The liquid and solid compositions are releasably disposed within the first and second compartments, respectively. In some aspects, the unit dose product comprises two compartments. In some aspects, the unit dose product can have more than 2 (e.g., 3 or 4) compartments that are sealed off from one another, and the liquid and solid compositions are releasably disposed within at least two of the compartments. In some aspects, the same solid composition is present in two compartments, while the liquid composition is disclosed in a third compartment that is adjacent to the compartments containing the solid compositions. In some aspects, different film compositions can be used to form different sections or compartments of the pouch. For example, different films can dissolve at different rates to provide timed release of the compartments' contents.

The sealing of a water-soluble film material (e.g., in the form of one or two sheets) to form a compartment can be performed using methods known to those of skill in the art. In some aspects, the water-soluble film material is sealed using heat-sealing, solvent sealing (e.g., water sealing), or ultraviolet (UV) sealing.

The first compartment is adjacent to the second compartment in any suitable configuration so long as the first and second compartments are separated by at least one layer of the water-soluble film. In an aspect, the second compartment surrounds (e.g., encircles) the first compartment. In an aspect, the first compartment surrounds (e.g., encircles) the second compartment. In another example, the first and second compartments share one side of the compartments.

The unit dose product can have any suitable shape and size, e.g., square, rectangular, oval, ellipsoid, superelliptical, or circular shape. Suitable structures are set forth in, e.g., U.S. D714,161, the disclosure of which is incorporated herein by reference in its entirety. In general, the size and shape of each compartment in the unit dose product is large enough to enclose (e.g., entrap) about 1 g to about 50 g total weight of each of the liquid and solid compositions. For example, each compartment can enclose about 1 g to about 45 g (e.g., about 1 g to about 40 g, about 1 g to about 35 g, about 1 g to about 30 g, about 1 g to about 25 g, about 1 g to about 20 g, or about 1 g to about 15 g). In some aspects, the first compartment comprising the liquid composition is smaller relative to the second compartment comprising the solid composition. In an aspect, the first compartment holds about 1 g to about 5 g of the liquid composition. In an aspect, the second compartment holds about 10 g to about 20 g of the solid composition.

The water-soluble film is desirably strong, flexible, shock resistant, and non-tacky during storage at both high and low temperatures and high and low humidities. Non-limiting examples of suitable materials for the water-soluble film include, e.g., polyvinyl alcohol (PVOH), polyvinyl acetate (PVA), film-forming cellulosic polymers, polyacrylic acid, polyacrylamide, polyanhydride, a polysaccharide, and combinations thereof. Examples of film-forming cellulosic polymer include, e.g., cellulose, cellulose ether, cellulose ester, cellulose amide, methylcellulose, carboxymethylcellulose sodium, ethylcellulose, hydroxyethyl cellulose, hydroxypropyl methyl cellulose (HPMC), and combinations thereof. Unit dose detergent packs, including water-soluble films, are described in U.S. Pat. Nos. 8,551,929, 10,774,294, and 11,492,574, the disclosures of which are incorporated herein by reference in their entirety. In some aspects, the water-soluble film material comprises polyvinyl alcohol, polyvinyl pyrrolidone, polyalkylene oxide, polyamide, polyacrylamide, polyacrylic acid, cellulose, a cellulose ether, a cellulose ester, a cellulose amide, polyvinyl acetate, polycarboxylic acid or a salt thereof, a peptide, a polysaccharide, a natural gum, or any combination thereof. In some aspects, the water-soluble film material comprises polyvinyl alcohol (PVOH) or polyvinyl acetate (PVA).

In an aspect, the water-soluble film material is polyvinyl alcohol (PVOH). In some aspects, the PVOH can have a number average molecular weight range of about 10,000 to about 100,000 g/mol (e.g., about 10,000 to about 80,000 g/mol, about 15,000 to about 60,000 g/mol, about 20,000 to about 50,000 g/mol, about 25,000 to about 40,000 g/mol, or about 27,000 to about 33,000).

In some aspects, the film material comprises a bitterant (e.g., denatonium benzoate), as described herein, to impart a bitter taste to help avoid accidental poisoning.

In some aspects, the film material can have a thickness of about 50 to about 100 μm (e.g., about 50 to about 90 μm, about 60 to about 100 μm, about 60 to about 90 μm, about 70 to about 100 μm, about 70 to about 90 μm, about 80 to about 100 μm, about 80 to about 90 μm, about 100 μm, about 99 μm, about 98 μm, about 97 μm, about 96 μm, about 95 μm, about 94 μm, about 93 μm, about 92 μm, about 91 μm, about 90 μm, about 89 μm, about 88 μm, about 87 μm, about 86 μm, about 85 μm, about 84 μm, about 83 μm, about 82 μm, about 81 μm, about 80 μm, about 79 μm, about 79 μm, about 78 μm, about 77 μm, about 76 μm, about 75 μm, about 74 μm, about 73 μm, about 72 μm, about 71 μm, about 70 μm, about 69 μm, about 68 μm, about 67 μm, about 66 μm, about 65 μm, about 64 μm, about 63 μm, about 62 μm, about 61 μm, about 60 μm, about 59 μm, about 58 μm, about 57 μm, about 56 μm, about 55 μm, about 54 μm, about 53 μm, about 52 μm, about 51 μm, or about 50 μm). In some aspects, the film material will have a thickness of about 80 to about 90 μm or about 88 μm.

In some aspects, the present disclosure is directed to a method of using the unit dose product of any of the foregoing aspects. For example, the unit dose product can be used in a method of removing soil from a textile (e.g., cleaning a textile, such as a fabric). In particular, the present disclosure is directed to a method of removing soil from a textile comprising contacting the textile with a composition comprising the unit dose product described herein and water to form a washing load. Optional steps include mixing (agitating) the washing load and composition, removing the composition to provide a clean textile, rinsing the clean textile with additional water, and isolating the clean textile. In some aspects, soils that are suitably removed using the unit dose product include, but are not limited to, oil-containing soils, carbohydrate-containing soils, protein-containing soils, tannin-containing soils, particulate soils, and combinations thereof.

In some aspects of these methods, the method can be performed using a washing machine, a tergotometer, or an equivalent device. In some aspects of these methods, the water is hot or warm water (e.g., about 21-35° C., about 22-32° C., about 25-35° C., about 25-32° C., about 28-35° C., about 30-35° C., or about 32° C.). In some aspects of these methods, the water is cold water (e.g., about 10-20° C., about 12-16° C., or about 15° C.).

In an aspect, the method is directed to providing a mild detergent composition.

In an aspect, the method is directed to providing an allergen-free detergent composition.

In an aspect, the method is directed to providing detergent compositions comprising Safer Choice ingredients.

### Examples

This example is provided for the purpose of illustration only and the embodiments described herein should in no way be construed as being limited to these examples. Rather, the embodiments should be construed to encompass any and all variations which become evident as a result of the teaching provided herein.

### Example 1

Liquid detergent formulations can be prepared with the components listed in Table 2.

TABLE 1

| | Activity | Formula 1 | Formula 2 |
|---|---|---|---|
| COMPONENT | % | (wt %) | (wt %) |
| Glycerin | 99+ | 19.23 | 14.73 |
| Propylene Glycol (PG) | 99+ | 0 | 8.21 |
| Polyethylene Glycol (PEG 400) | 99+ | 28.85 | 5.8 |
| SDA-3C Ethanol (200 Proof) | 100 | 3 | 3 |
| Fatty Alcohol Ethoxylate (AE) (25-7) | 99+ | 24.13 | 23.07 |
| Linear Alkylbenzene Sulfate | 96 | 0 | 17 |
| Alkyl Ether Sulfate, 3EO, 70% paste | 70 | 4.8 | 4.8 |
| Coconut Fatty Acid | 100 | 6 | 6 |
| Monoethanolamine | 99+ | 1.4 | 4.8 |
| Water | 100 | 10.5 | 10.5 |
| Optical Brightener, 33% | 100 | 2.08 | 2.08 |
| Iminodisuccinic Acid | | | |
| Solution, 15% Sodium Sulfite | | | |
| Solution, Bittering Agent | | | |
| Total of Liquid Composition | | 100.00 | 100.00 |

A detergent formulation for a unit dose package comprising a liquid composition in combination with a solid composition can be prepared in accordance with the components listed in Table 2.

TABLE 2

| | | Total |
|---|---|---|
| COMPONENT | Chamber | Weight (g) |
| Glycerin | Liquid Composition | about 12 to |
| Polyethylene Glycol (PEG 400) | (e.g., Formula | about 20 |
| SDA-3C Ethanol (200 Proof) | 1 or 2) | |
| Fatty Alcohol Ethoxylate (AE) (25-7) | | |
| Alkyl Ether Sulfate, 3EO, 70% paste | | |
| Coconut Fatty Acid | | |
| Monoethanolamine | | |
| Water | | |
| Iminodisuccinic Acid | | |
| Sodium Sulfite, | | |
| 15% solution | | |
| Optical Brightener (optional) | Solid Composition | about 1 to |
| Enzymes (optional) | | about 4 |
| Solid Methyl Ester Sulfonate blend | | |
| with a Carbon Chain length of C16 | | |
| (75-85%) and C18 (15-25%) | | |
| Performance Polymer (optional) | | |
| Total | 2 | about 13 to |
| | | about 24 |

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A unit dose product comprising
a water-soluble film material comprising a first compartment and a second compartment;
the first compartment enclosing a liquid composition comprising about 5 to about 20 weight percent (wt %) water relative to the liquid composition, a non-aqueous solvent, and optionally an additive selected from surfactant, a base, an anti-redeposition agent, a performance polymer, a defoamer, an enzyme, a chelating agent, an optical brightener, a bitterant, a corrosion inhibitor, and any combination thereof; and
the second compartment enclosing a solid composition comprising a solid methyl ester sulfonate (MES) and/or a solid cocoyl isethionate.

2. The unit dose product of claim 1, wherein a Zein score of a combined composition comprising the liquid and solid compositions dissolved in water is not more than 2% dissolved zein when tested on a 3% dilution.

3. The unit dose product of claim 2, wherein the Zein score of the combined composition is not more than 1% dissolved zein when tested on a 3% dilution.

4. The unit dose product of claim 1, wherein the solid composition is a powder or granule.

5. The unit dose product of claim 1, wherein the solid composition comprises about 5 to about 30 wt % of solid methyl ester sulfonate (MES) relative to the total unit dose product.

6. The unit dose product of claim 1, wherein the solid composition further comprises a solid flow aid comprising a chloride, a bromide, an iodide, a fluoride, a nitrate, a nitrite, a sulfate, a sulfite, a sulfide, a phosphate, a phosphide, a carbonate, a bicarbonate, a citrate, silica, calcium oxide, a silicate, an aluminate, a stearate, clay, flour, fly ash, starch, zeolite, or any combination thereof.

7. The unit dose product of claim 1, wherein the solid composition further comprises an additive selected from an anti-redeposition agent, enzyme, chelating agent, and any combination thereof.

8. The unit dose product of claim 1, wherein the liquid composition comprises an alcohol ethoxylate (AE), an alkyl ether sulfate (AES), a methyl ester ethoxylate, coco fatty acid, an alkyl polyglucoside, or any combination thereof.

9. The unit dose product of claim 8, wherein the liquid composition comprises an alcohol ethoxylate (AE) and an alkyl ether sulfate (AES).

10. The unit dose product of claim 1, wherein the liquid composition does not comprise a linear alkylbenzene sulfonate.

11. The unit dose product of claim 1, wherein the non-aqueous solvent comprises an alcohol, a polyol, or a combination thereof.

12. The unit dose product of claim 11, wherein the non-aqueous solvent comprises about 5 to about 35 wt % polyethylene glycol, 0 wt % to about 10 wt % propylene glycol, and about 10 to about 25 wt % glycerin.

13. The unit dose product of claim 11, wherein the non-aqueous solvent comprises polyethylene glycol, propylene glycol, and glycerin in a weight ratio of about 3-5:1:1.

14. The unit dose product of claim 1, wherein the liquid composition has a pH of about 6.5 to about 10.

15. The unit dose product of claim 14, wherein the liquid composition has a pH of about 7 to about 8.

16. The unit dose product of claim 1, wherein the liquid composition comprises a base selected from the group consisting of monoethanolamine, diethanolamine, triethanolamine, methyl diethanolamine, a hydroxide, a tetraborate, a phosphate, a carbonate, a bicarbonate, or a combination thereof.

17. The unit dose product of claim 1, wherein the liquid composition comprises an enzyme selected from a protease, an amylase, a mannanase, a lactase, a lipase, a perhydrolase, an oxidoreductase, a cellulase, a pectinase, or any combination thereof.

18. The unit dose product of claim 1, wherein the water-soluble film material comprises polyvinyl alcohol (PVOH) or polyvinyl acetate (PVA).

19. A unit dose product comprising
a water-soluble film material comprising a first compartment and a second compartment;
the first compartment enclosing a liquid composition comprising
a non-aqueous solvent comprising polyethylene glycol and glycerin, and
a surfactant selected from an alcohol ethoxylate (AE), an alkyl ether sulfate (AES), a methyl ester ethoxylate, coco fatty acid, an alkyl polyglucoside, and any combination thereof; and
the second compartment enclosing a powder composition comprising
a methyl ester sulfonate (MES) of the formula R¹CH(SO₃X¹)(C(═O)OCH₃), wherein
R¹ is a C₁₂-C₂₄ alkyl and X¹ is a cation that balances the charge and/or
a cocoyl isethionate of the formula R²C(O)OCH₂CH₂SO₃X², wherein R² is a C₇-C₁₇ alkyl and X² is a cation that balances the charge and
a solid flow aid.

20. The unit dose product of claim 19, wherein R¹ is a C₁₆-C₁₈ alkyl.
